(19) United States
(12) Patent Application Publication
(10) Pub. No.: US 2025/0034757 A1
(43) Pub. Date: Jan. 30, 2025

(54) PROCESS FOR FABRICATION OF REGENERATED CELLULOSE YARNS DERIVED FROM RECYCLED WASTE FEEDSTOCKS

(71) Applicants: HEIQ MATERIALS AG, Schlieren (CH); Technikum Laubholz GmbH, Göppingen (DE)

(72) Inventors: Murray J. HEIGHT, Newtown, Victoria (AU); Enrique HERRERO ACERO, Wien (AT); Uwe PIELES, Müllheim (DE)

(73) Assignees: HEIQ MATERIALS AG, Schlieren (CH); Technikum Laubholz GmbH, Göppingen (DE)

(21) Appl. No.: 18/716,650

(22) PCT Filed: Dec. 1, 2022
(86) PCT No.: PCT/EP2022/084070

§ 371 Date: Jun. 5, 2024

(30) Foreign Application Priority Data
Dec. 6, 2021 (EP) 21212418.4

(51) Int. Cl. D01D 5/00; C08B 16/00; C08J 11/02; C08J 11/08; D01D 1/02; D01D 1/06; D01F 2/02

(52) U.S. Cl. CPC D01D 5/0046; C08B 16/00; C08J 11/02; C08J 11/08; D01D 1/02; D01D 1/065; D01F 2/02; C08J 2301/24; D10B 2201/24

(57) ABSTRACT

Method for the production of cellulose yarns from recycling cellulose material, wherein the method includes the following steps: (a) dissolution of the recycling cellulose material in a molten ionic liquid; (b) adapting the conditions such that active substances dissolved or dispersed in the molten ionic liquid or generated in situ in the molten ionic liquid act to degrade non-cellulose material initially contained in the recycling cellulose material and contained in the molten ionic liquid due to the dissolution of the recycling cellulose material, wherein the active substances can already be present during (a) or can be added after (a) and before or during (b).

### TECHNICAL FIELD

The present invention relates to a process for conditioning recycled materials containing cellulose based on dissolution in ionic liquids and addition of active substances to degrade and remove colors and/or modify the molecular weight distribution of the cellulose polymers. The process enables direct processing of recycled materials and subsequent spinning into fibers. The process is advantageous for enabling processing of a wide range of post-consumer and post-industrial recycled articles for reuse in production of regenerated cellulose fibers.

### PRIOR ART

Recycling in the textile field has become increasingly important, however its implementation and impact remains far from reaching its ultimate potential. In fact most of the recycled textiles are not recycled to the same level again, but rather used after recycling for low level applications, e.g. for use as construction materials (insulation), et cetera. There is a need to provide for circular methods which allow the recycling of textiles in a way which allows the recycled material to be reused at an as high as possible level, ideally for producing the same kind of textiles as used as input for the recycling.

The sustainability profile of regenerated cellulose yarns can be further improved when cellulose sources based on recycled cellulose raw materials are used. Examples include post-industrial fabrics and post-consumer apparel such as articles that contain cotton, viscose, lyocell and other forms of cellulose. Additional cellulose-containing streams (e.g. agricultural waste, pulp, bacteria-derived cellulose, algae-derived cellulose etc.) may also be used as sources of cellulose.

Key challenges of using post-consumer articles include the following:
Wide assortment of colors due to dyestuffs in apparel items;
Impurities such as fats, oils, mineral matter picked up during the use of the articles;
Presence of non-cellulose components in the articles (e.g. synthetic blend components, sewing thread, surface treatments, zippers, buttons etc.).

Conventional processing techniques to address the above challenges involve intensive scouring and bleaching steps that involve significant consumption of water and energy to provide clean and color-free cellulose.

Conventional approaches to remove non-cellulose components involve mechanical disassembly for macro items or selective dissolution for different fiber components. U.S. Pat. No. 8,841,441 relates to a method for producing regenerated biopolymers in the form of carbohydrates, using a solvent system that contains the biopolymers dissolved therein. The solvent system is based on a melted ionic liquid and optionally a protic solvent or a mixture thereof. The biopolymers dissolved in the solvent system are precipitated in a coagulation medium, said medium comprising a protic coagulant or a mixture of protic coagulants. The method according to the invention is characterized in that the surface tension a of the coagulant or the mixture of coagulants is 99% to 30% of the surface tension a of water, the surface tension being measured according to ASTM D 1590-60 at a temperature of 50° C. The method according to the invention is economical and flexible and leads to advantageous products, especially in the form of staple fibers which are especially not fibrillated and have an advantageous wet to dry strength ratio.

CN-A-106146877 discloses a method for recovering waste textile by the aid of an ionic liquid. The method comprises steps as follows: 1) pretreatment of the waste textile: the waste textile is crushed, and pretreated waste textile is obtained; 2) water swelling and dissolution in the ionic liquid: the pretreated waste textile, the ionic liquid and water are mixed and stirred under the vacuum condition, and a liquid containing cellulose is obtained. After the waste textile is pretreated and swollen in water, the dissolution process is uniform and mild, the dissolution efficiency is high, the effect is good, and the waste textile is thoroughly separated from insoluble matters. A cellulose solution obtained through dissolution can be used for preparing a regenerated cellulose material with excellent performance, and polyester obtained through separation can serve as a polyester raw material to be recycled.

### SUMMARY OF THE INVENTION

Regenerated cellulose yarns produced with ionic liquids (IL) can offer appealing fiber properties and a better sustainability profile (e.g. reduced global warming potential, energy use, biodegradability) compared to fibers from synthetic polymers such as polyester and polyamide.

Conventional approaches to tackle the above key challenges for recycling would involve distinct processing steps preceding, and separate to, the preparation of a ionic liquid cellulose dope and subsequent fiber spinning.

The approach presented here provides a means of directly processing recycled cellulose-containing articles in a medium containing ionic liquid to achieve the following:
Direct dissolution of recycled cellulose-containing articles to prepare a dope for subsequent fiber spinning;
The dissolution firstly acts to separate out the non-soluble components e.g. synthetic fibers, mineral matter;
Active substances dispersed in the ionic liquid (or generated in-situ) act to degrade the diverse dyestuffs associated with the cellulose, and also to degrade fatty and other organic impurities;
Absorbents (inert and inorganic) may be homogeneously dispersed in the IL to specifically absorb impurities e.g. dyes and other unwanted ingredients. The loaded absorbents are filtered off from the cellulose-IL solution and may be reused after a suitable regeneration process.

Active substances may also be chosen in such a way to reduce the molecular weight of the cellulose polymer chains to assist in subsequent fiber spinning. Reduction of molecular weight can be achieved through introduction of ozone or another active gas to the IL or by exposure to short wavelength radiation e.g. UV light or photocatalysis in the presence of a catalyst.

Following dissolution of the cellulose materials in the ionic liquid the active reagents (e.g. hydrogen peroxide and/or enzymes and/or catalyst salts) are added and the mixture is heated while stirring to a temperature between 4° and 120° C. and maintained at temperature for 0.5 to 24 hours duration to achieve the desired decolorization. The resulting solution may then be heated/cooled to achieve the desired target temperature and then may be used directly to the fiber spinning process.

Key advantages for the proposed method include:
1. Degradation of diverse dyestuffs directly and/or removal by a specific absorbents in the ionic liquid processing medium that can be directly used in subsequent fiber spinning. Enables a wide range of recycled sources to be used to generate fresh non-colored yarn.
2. Degradation of fats, oils and other organic impurities that would otherwise impact yarn quality.
3. Selective dissolution of cellulose and separation of insoluble components (e.g. synthetic polymer components, mineral matter).
4. Processing directly within the ionic liquid medium used for subsequent fiber spinning avoids intensive conventional pre-processing steps that would otherwise require intensive water and energy use, further improving the sustainability profile of the recycling path. The resulting processing path requires less processing steps and enables a more direct utilization of recycled waste materials containing cellulosic components.
5. Use of ionic liquids and fiber spinning process as described by WO2007076979 and WO2009062723 (the disclosure of which is included) provides a basis for achieving favorable regenerated cellulose fibers with ionic liquids that are tolerant to significant presence of protic components including water. The process advantageously enables the pre-processing active substances that provide the in-situ decolorization and impurity degrading/absorbing actions without impacting the performance of the subsequent fiber spinning. This pre-processing would otherwise not be feasible with ionic liquid systems and fiber spinning processes that are less tolerant of water content.
6. Use of catalytic chemistry (enzymes, ozone, short wavelength radiation) vs. stoichiometrical chemistry currently used for the adjusting of cellulose degree of polymerisation (DP) (e.g. NaOH), in situ generation of H₂O₂ in direct proximity to the substances to bleach reduces the amount of H₂O₂ required vs. a dosing in the bulk phase translates in less chemicals needed.

It is one of the key features of the present invention, that it was surprisingly found that ionic liquids can be used also for the dissolution or dispersion of active substances, e.g. can tolerate water or other protic solvents up to certain amount for the dissolution of cellulose and spinning while achieving excellent fiber properties, allowing at the same time for the introduction of catalytic components which do not increase the water or other protic solvents levels to a level that would adversely impact proper fiber spinning and consequently the fiber properties.

Degradation/absorbing of dyestuffs and organic impurities is possible as follows:
Bleaching/decolorization of dyestuffs associated with recycled cellulose directly within the ionic liquid medium used to dissolve the cellulose components.
Possible approaches include:
Addition of (in)organic absorbents, which will be filtered off after absorbing the impurities and can be subjected to a recycling process;
Addition of hydrogen peroxide or ozone to the ionic liquid solution of cellulose or exposed to short wavelength light or photocatalysis;
In situ generation of bleaching active substances like hydrogen peroxide through addition of enzymes to the ionic liquid solution of cellulose (e.g. cellobiose dehydrogenase for the localized generation of H2O2, but also peroxidases can take H2O2 and produce radicals able to bleach);
Addition of enzymes e.g. Laccases to decolorize and destroy impurities.
In each case the hydrogen peroxide breaks down into residual water (ionic liquid process is tolerant to presence of remaining water), oxygen and non-colored residual degradation by-products. The residual by-products may optionally be removed directly without degradation or through use of sorbent materials after its breakdown in contact with the ionic liquid processing medium.

Reduction in molecular weight of cellulose is advantageous and possible as follows:
The molecular weight of the cellulose polymer has a direct impact on the fiber spinning performance and also the mechanical properties of the resulting yarn;
For some recycled cellulose raw materials (e.g. cotton-rich apparel) it may be advantageous to reduce the molecular weight distribution of the cellulose to enable improved fiber spinning performance and fiber properties;
Reduction of the molecular weight may occur through action of hydrogen peroxide alone and/or with addition of other components e.g. ozone or UV light or photocatalysis selected to cleave the cellulose polymer resulting in reduced average molecular weight;
Such additives may include enzymes and/or salts. The action of such additives in the ionic liquid medium is facilitated by the presence of water in the ionic liquid that is a feature of WO2007076979 and WO2009062723 (the disclosure of which is included).

The use of enzymes (e.g. Laccases) to decolorize dyestuffs is established art in detergents and laundry processing. The use of active substances like for example enzymes to achieve decolorization effect in ionic liquid processing medium is a new feature of the present invention.

The use of hydrogen peroxide in ionic liquid for oxidative conversion of lignocellulosic feedstock is described in US10724060 however the patent instructs that the action of the hydrogen peroxide is targeting degradation of lignin—degradation of color components such as dyestuffs associated with recycled cellulose materials is not addressed. US10724060 also mentions use of cellulases and/or hemicellulases however the enzyme components are specifically selected to convert the biomass into sugar components from cellulose rather than reducing the molecular weight while maintaining the cellulose polymer character. It is important to note that US10724060 contacts oxidizing substances and enzymatic substances in aqueous medium prior to a subsequent process step for the addition of ionic liquids.

WO2016087186A1 and US8445704 describe use of ionic liquids as a processing medium for chemical modification and transformation of polysaccharides however there is no use of hydrogen peroxide/ozone, short wavelength radiation, photocatalysis and/or enzymes to address colors and impurities or to address the molecular weight of the cellulose.

US11168196 describes an approach to facilitate separation of blended cellulose/polyester waste however there is no provision for actively addressing colors, impurities, and/or molecular weight within the ionic liquid used to dissolve the cellulose component.

More generally speaking, the present invention relates to a method for the production of cellulose yarns from recycling cellulose material, wherein the method comprises the following steps:
(a) dissolution of the recycling cellulose material in solution containing at least a molten ionic liquid;
(b) adapting the conditions such that active substances dissolved or dispersed in the molten ionic liquid or generated in situ in the molten ionic liquid act to degrade non-cellulose material initially contained in the recycling cellulose material and contained in the molten ionic liquid due to the dissolution of the recycling cellulose material, wherein the active substances can already be present during (a) or can be added after (a) and before or during (b).

The adaptation of the conditions according to step (b) can be carried out in different ways, for example by changing the solvent composition, by adding said active substances (alone or in a carrier solvent), by activating said active substances, by changing the temperature, the pH or by changing the pressure, or by introducing activation energy for example by irradiation, or a combination of such adaptations.

The term active substance in the context of (b) includes substances which are suitable and adapted to fulfil the function to degrade non-cellulose material initially contained in the recycling cellulose material, and examples thereof are given further below.

The recycling cellulose material is preferably selected from at least one of cellulose waste, recycling yarns, recycling fabrics, recycling tissue, recycling clothing.

The non-cellulose material is typically selected from at least one of dyestuffs, fatty and other organic impurities, including oils, waxes and detergent residues, inorganic substances such as sand or clay, water soluble and water insoluble pigments.

After step (a) and before or after step (b) there can be and preferably there is a step (c) of separation of non-dissolved or non-dissolvable impurities due to the dissolution of the recycling cellulose material or of absorbents, wherein preferably this step includes at least one of filtration, decanting, centrifugation, sieving.

The ionic liquid solution preferably comprises a protic liquid, preferably water.

The active substance is preferably selected from the group of absorbents, cleaving agents, including biological cleaving agents, physical cleaving agents and chemical cleaving agents, wherein preferably absorbents are selected from the group of substances adsorbing at least one of dyestuffs, fatty impurities and other organic impurities, and wherein preferably cleaving agents are selected from the group of direct cleaving agents or activatable cleaving agents, preferably activated by irradiation of electromagnetic irradiation, wherein the cleaving agents can be selected from the group of enzymatic systems including proteases, oxidoreductases, amylases, laccases and lipases, ozone, peroxides, photocatalysts, and a combination thereof. In the examples given further below for the active substance hydrogen peroxide is used. However this is just one possibility and the above-mentioned substances can fulfil the function of the active substance in a complementary and/or alternative way to this example with hydrogen peroxide.

Preferably, the ionic liquid from the beginning comprises or is supplemented after step (b) or after (c), if present, with a system to reduce the molecular weight of the cellulose polymer, preferably selected from the group of enzymatic systems including cellulases or hemicellulases or cellulose oxidases, in particular endoglucanases, exoglucanases or cleaving agents activated by irradiation of electromagnetic irradiation, or strong bases, or a combination thereof.

In step (b) the temperature is preferably increased to a range of 40-120° C., and preferably maintained at this temperature for a timespan in the range of 0.5-24 hours.

After step (b) or after step (c) the cellulose yarn can directly be spun from the cellulose dissolved in the ionic liquid.

Said molten ionic liquid further preferably comprises a protic solvent or a mixture of several protic solvents, wherein, in the case where the protic solvent is solely water, the water is present in the solution system in an amount of more than 5 wt. %, the cellulose dissolved in the molten ionic liquid are precipitated in a coagulation medium, the coagulation medium comprising a solvent which does not dissolve the cellulose and is miscible with the molten ionic liquid, wherein preferably the molten ionic liquid is comprising a cation that is formed from compounds which contain at least one five-to six membered heterocyclic ring and a protic solvent, and the process involves precipitating dissolved cellulose in the form of carbohydrates in a coagulation medium, comprising a solvent which does not dissolve the cellulose and is miscible with the molten ionic liquid, wherein said protic solvent is selected from the group consisting of
1) water as the sole protic solvent which is present in said solution system in an amount of at least 5 or 6 wt. %,
2) at least 0.1 wt. % based on said solution system of at least one protic solvent selected from the group consisting of alcohols such as methanol, ethanol, 1-propanol, 2-propanol 1-butanol, amylalcohol and linear and branched alcohols and higher linear and branched alcohols; and
3) water and at least one protic solvent selected from the group consisting of alcohols, carboxylic acids or amines, such as methanol, ethanol, 1-propanol, 2-propanol and 1-butanol, amylalcohol and linear and branched alcohols and higher linear and branched alcohols.

Suitable systems acting as ionic liquids are for example those, which are described in U.S. Pat. No. 8,163,215 or in U.S. Pat. No. 8,841,441, the disclosure of which is included into this specification as concerns the ionic liquid systems.

Ionic liquids in the context of the present invention are preferably

(A) salts of the general formula (I):

[A]⁺ₙ[Y]ₙ⁻ (I)
in which n represents 1, 2, 3 or 4, [A]⁺ represents a quatemary ammonium cation, an oxonium cation, a sulfonium cation or a phosphonium cation and [Y]ₙ⁻ represents a mono-, di-, tri- or tetravalent anion;
or they are (B) mixed salts of the general formulae (II)

[A¹]⁺[A²]⁺[Y]ⁿ⁻ (IIa),
wherein n=2;

[A¹]⁺[A²][A³]⁺[y]ⁿ⁻ (IIb),
wherein n=3; or

[A¹]⁺[A²]+[A³]⁺[A⁴]⁺[Y]ⁿ⁻ (IIc),
wherein n=4; and
wherein [A¹]⁺, [A²]⁺, [A³]⁺ and [A⁴]⁺ independently of one another are chosen from
the groups mentioned for [A]⁺ and [Y]ⁿ⁻ has the meaning mentioned under (A).

Possible is e.g. the use of 1-ethyl-3-methylimidazolium chloride. This is also what is used in the examples, but this is just one possibility and the ionic liquid substances mentioned in this general section can act as such equally in a complementary (ionic liquid mixture) and/or alternative way to this example with 1-ethyl-3-methylimidazolium chloride. In particular systems based on methylimidazolium, in particular based on 1-ethyl-3-methylimidazolium, clearly fulfil the same function, so 1-ethyl-3-methylimidazolium with different anions such as fluoride, acetate, or dicyanamide, (C₂H₅)(CH₃)C₃H₃N⁺₂·N(CN)⁻₂, and also systems based on 1-butyl-2,3-dimethylimidazolium or 1-butyl-3,5-dimethylpyridinium, 1-butyl-3-methylimidazolium, such as 1-butyl-3,5-dimethylpyridinium bromide, 1-butyl-3-methylimidazolium hexafluorophosphate, 1-butyl-3-methylimidazolium bis(trifluoromethylsulfonyl)imide or combinations thereof.

Compounds which are suitable for forming the cation [A]+ of ionic liquids are known e.g. from DE 102 02 838 A1. Such compounds can thus contain oxygen, phosphorus, sulfur or, in particular, nitrogen atoms, for example at least one nitrogen atom, preferably 1 to 10 nitrogen atoms, particularly preferably 1 to 5, very particularly preferably 1 to 3 and in particular 1 to 2 nitrogen atoms. They can optionally also contain further hetero atoms, such as oxygen, sulfur or phosphorus atoms. The nitrogen atom is a suitable carrier of the positive charge in the cation of the ionic liquid, from which a proton or an alkyl radical can then transfer to the anion in equilibrium in order to generate an electrically neutral molecule. The system of the ionic liquid may also be one based systems containing a cationic 1,5,7-triazabicyclo[4.4.0]dec-5-enium [TBDH]+ moiety and an anion selected from the group according to Formula a), Formula b) and Formula c),

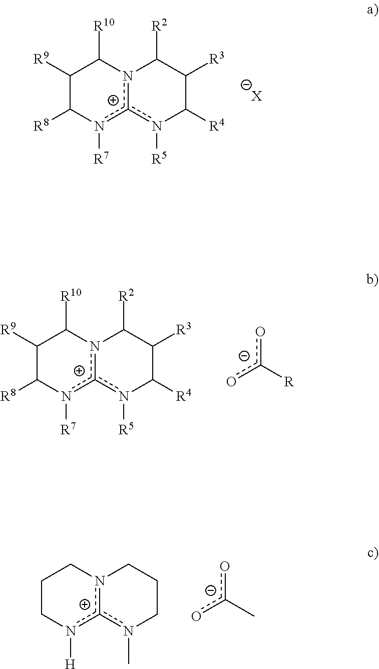

as for example described in WO2018/138416, which is also included into this specification as concerns ionic liquid systems.

According to yet another preferred embodiment, said molten ionic liquid comprises a protic solvent or a mixture thereof, and the method involves precipitating the cellulose in a coagulation medium, a protic coagulation agent or a mixture of protic coagulation agents being present in the coagulation medium, and wherein the surface tension a of the protic coagulation agent or the mixture of protic coagulation agents is 99% to 30% of the surface tension a of water, each surface tension being measured in accordance with ASTM D 1590-60 at a temperature of 50° C., wherein preferably the protic coagulation agent is selected from 1-hexanol, 1-heptanol, 1-octanol, 1-nonanol, 1-decanol, 1-undecanol, 1-dodecanol, 1-tridecanol, 1-tetradecanol, 2-ethyl-1-hexanol, 1,2-ethanediol, 1,2-propanediol, 1,3-propanediol, 1,2-butanediol, 1,3-butanediol, 1,4-butanediol, 1,5-pentanediol, 1,6-hexanediol, 1,2,3-propanetriol, 2,2-dimethyl-1,5-propanediol, cyclohexanol, diethylene glycol, triethylene glycol and mixtures thereof, and wherein further preferably the coagulation medium does not contain more than 5% of carboxylic acid.

According to a further aspect of the present invention it relates to cellulose yarn produced using a method as described above.

According to yet another aspect of the present invention, it relates to the use of cellulose yarn as given above for the production of textiles, in particular of clothing.

The produced cellulose yarn may be used directly in a variety of textile processes including texturizing; twisting; covered yards (core spun yarns); knitting; weaving; seamless; circular knitting with other yarns (such as cotton, nylon, polyester, polypropylene, cellulosics, wool, silk, polyurethane); warp knitting; beaming process; staple fibers; nonwovens. The produced cellulose yarn may be used directly in a variety of textile forms including Denim; Hosiery; Intimate; Sportswear; Fashion; Shoes; Sewing threads; Upholstery; Home textiles; Industrial textiles.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic process steps for conventional processing of recycled cellulose into regenerated cellulose fibers compared to the invention.

### DESCRIPTION OF PREFERRED EMBODIMENTS

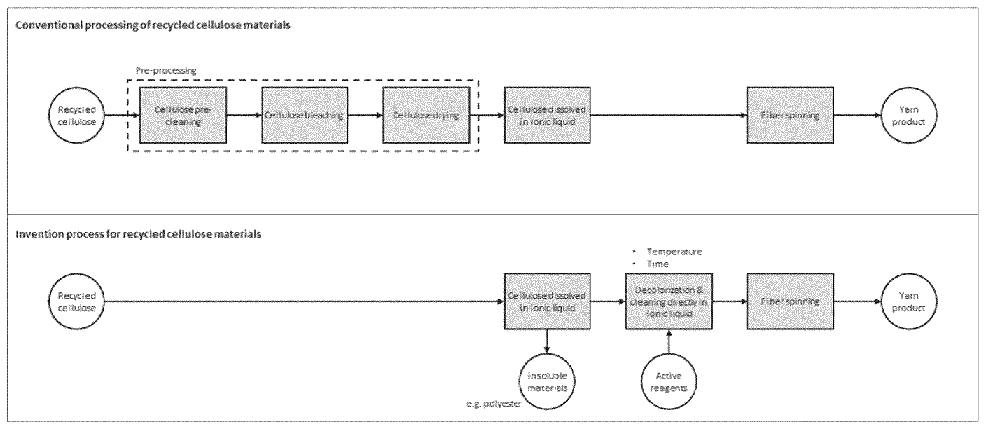

FIG. 1 shows in the upper row a schematic process for conventional pre-processing of recycled cellulose materials to remove colors and impurities followed by dissolution in ionic liquid and subsequent fiber spinning. In contrast the present invention as illustrated in the lower row involves direct dissolution of the recycled cellulose in ionic liquid enabling colors and impurities to be processed directly in the ionic liquid dope with subsequent fiber spinning. The present invention enables reduced process complexity and reductions in energy and water use compared to conventional processes.

### Experimental Example

A knitted fabric composed of 100% viscose yarn was dyed with a red azo dyestuff (Basic Red 46) using a laboratory exhaust dyeing system followed by cleaning and laundry. A small (30 cm×30 cm) portion of the fabric (ca. 10 g) was manually cut from the material and further cut into ca. 3 cm×3 cm pieces. A glass beaker was prepared with 96 g of an ionic liquid (1-Ethyl-3-methylimidazolium chloride) and 4 g of deionized water. The ionic liquid mixture was heated and maintained at a temperature of 90° C. The fabric pieces were stirred manually into the molten ionic liquid (IL) until the added material was observed to dissolve to a homogeneous solution. The initially prepared solution was observed to display a strong red color. A 4 g quantity of hydrogen peroxide was added gradually to the ionic liquid solution while maintaining gentle agitation with a magnetic stirrer. The stirred solution was maintained at 90° C. for a period of 6 hours. The resulting solution was observed to have a pale red color with significantly diminished color intensity consistent with degradation of the azo dye stuff associated with the dissolved cellulose.

The decolorized cellulose IL solution prepared above was loaded into a heated extrusion chamber and maintained at 90° C. The outlet nozzle orifice of the chamber was positioned above a coagulation bath of water maintained at 20° C. with an air-gap separation distance of 20 mm. A monofilament of regenerated cellulose was produced by injecting the cellulose IL solution into the coagulation bath and drawing the solidified cellulose filament at ca. 20 m/min through the coagulation bath and into a subsequent washing bath of water maintained at 60° C. The produced regenerated cellulose filament material showed a pale red color in comparison to dark red filament produced in the absence of conditioning with hydrogen peroxide.

1. A method for the production of cellulose yarns from recycling cellulose material, wherein the method comprises the following steps:
(a) dissolution of the recycling cellulose material in solution containing at least a molten ionic liquid;
(b) adapting the conditions such that active substances dissolved or dispersed in the solution containing molten ionic liquid or generated in situ in the solution containing molten ionic liquid act to degrade non-cellulose material initially contained in the recycling cellulose material and contained in the solution containing molten ionic liquid due to the dissolution of the recycling cellulose material, wherein the active substances are either already present during (a) and/or are added after (a) and before or during (b).

2. The method according to claim 1, wherein the recycling cellulose material is selected from at least one of cellulose waste, recycling yarns, recycling fabrics, recycling tissue, recycling clothing, other cellulose containing waste streams.

3. The method according to claim 1, wherein the non-cellulose material is selected from at least one of dyestuffs, fatty and other organic impurities including oils, waxes and detergents and residues thereof, inorganic substances including sand, clay, water-soluble and water-insoluble pigments.

4. The method according to claim 1, wherein after step (a) and before or after step (b) there is a step (c) of separation of non-dissolved or non-dissolvable impurities due to the dissolution of the recycling cellulose material or of absorbents.

5. Method according to claim 1, wherein the solution containing ionic liquid comprises a protic liquid.

6. The method according to claim 1, wherein the active substance is selected from the group of absorbents, cleaving agents, including biological cleaving agents, physical cleaving agents and chemical cleaving agents and a combination thereof.

7. The method according to claim 1, wherein the solution containing ionic liquid from the beginning comprises or is supplemented after step (b) or after (c), if present, with a system to reduce the molecular weight of the cellulose polymer.

8. The method according to claim 1, wherein in step (b) the temperature is increased to a range of 40-120° C.

9. The method according to claim 1, wherein after step (b) or after step (c) the cellulose yarn is directly spun from the cellulose dissolved in the solution containing ionic liquid.

10. The method according to claim 1, wherein said molten ionic liquid comprises a protic solvent or a mixture of several protic solvents, the cellulose dissolved in the molten ionic liquid are precipitated in a coagulation medium, the coagulation medium comprising a solvent which does not dissolve the cellulose and is miscible with the molten ionic liquid, and a protic solvent, and the process involves precipitating dissolved cellulose in the form of carbohydrates in a coagulation medium, comprising a solvent which does not dissolve the cellulose and is miscible with the molten ionic liquid.

11. The method according to claim 10, wherein
said protic solvent is selected from the group consisting of
1) water as the sole protic solvent which is present in said solution system in an amount of at least 5 or 6 wt. %,
2) at least 0.1 wt. % based on said solution system of at least one protic solvent selected from the group consisting of alcohols, carboxylic acids or amines, including methanol, ethanol, 1-propanol, 2-propanol and 1-butanol as well as amylalcohol and linear and branched alcohols and higher linear and branched alcohols; and
3) water and at least one protic solvent selected from the group consisting of methanol, ethanol, 1-propanol, 2-propanol and 1-butanol.

12. The method according to claim 1, wherein said molten ionic liquid comprises a protic solvent or a mixture thereof, and the method involves precipitating the cellulose in a coagulation medium, a protic coagulation agent or a mixture of protic coagulation agents being present in the coagulation medium, and wherein the surface tension a of the protic coagulation agent or the mixture of protic coagulation agents is 99% to 30% of the surface tension a of water, each surface tension being measured in accordance with ASTM D 1590-60 at a temperature of 50° C.

13. The method according to claim 1, wherein the protic coagulation agent is selected from 1-hexanol, 1-heptanol, 1-octanol, 1-nonanol, 1-decanol, 1-undecanol, 1-dodecanol, 1-tridecanol, 1-tetradecanol, 2-ethyl-1-hexanol, 1,2-ethanediol, 1,2-propanediol, 1,3-propanediol, 1,2-butanediol, 1,3-butanediol, 1,4-butanediol, 1,5-pentanediol, 1,6-hexanediol, 1,2,3-propanetriol, 2,2-dimethyl-1,5-propanediol, cyclohexanol, diethylene glycol, triethylene glycol and mixtures thereof.

14. A cellulose yarn produced using a method according to claim 1.

15. Method of use of cellulose yarn according to claim 12 for the production of textiles.

16. The method according to claim 1, wherein after step (a) and before or after step (b) there is a step (c) of separation of non-dissolved or non-dissolvable impurities due to the dissolution of the recycling cellulose material or of absorbents, wherein this step includes at least one of filtration, decanting, centrifugation, sieving.

17. The method according to claim 1, wherein the solution containing ionic liquid comprises water, in an amount of more than 2%, or more than 4% or more than 5 wt. %.

18. The method according to claim 1, wherein the active substance is selected from the group of absorbents, cleaving agents, including biological cleaving agents, physical cleaving agents and chemical cleaving agents, wherein absorbents are selected from the group of substances adsorbing at least one of dyestuffs, fatty impurities and other organic impurities, and wherein cleaving agents are selected from the group of direct cleaving agents or activatable cleaving agents, including activated by irradiation of electromagnetic irradiation, wherein the cleaving agents can be selected from the group of enzymatic systems including proteases, amylases, laccases, oxidoreductases, and lipases, ozone, peroxides, photocatalysts, and a combination thereof.

19. The method according to claim 1, wherein the solution containing ionic liquid from the beginning comprises or is supplemented after step (b) or after (c), if present, with a system to reduce the molecular weight of the cellulose polymer, selected from the group of enzymatic systems including cellulases or hemicellulases or cellulose oxidases, including exoglucanases and/or endoglucanases, or cleaving agents activated by irradiation of electromagnetic irradiation, or strong bases, or a combination thereof.

20. The method according to claim 1, wherein in step (b) the temperature is increased to a range of 40-120° C., and maintained at this temperature for a timespan in the range of 0.5-24 hours.

21. The method according to claim 1, wherein said molten ionic liquid comprises a protic solvent or a mixture of several protic solvents, wherein, in the case where the protic solvent is solely water, the water is present in the solution system in an amount of more than 5 wt. %, the cellulose dissolved in the molten ionic liquid are precipitated in a coagulation medium, the coagulation medium comprising a solvent which does not dissolve the cellulose and is miscible with the molten ionic liquid, wherein the molten ionic liquid is comprising a cation that is formed from compounds which contain at least one five-to six membered heterocyclic rings and a protic solvent, and the process involves precipitating dissolved cellulose in the form of carbohydrates in a coagulation medium, comprising a solvent which does not dissolve the cellulose and is miscible with the molten ionic liquid.

22. The method according to claim 1, wherein the coagulation medium does not contain more than 5% of carboxylic acid.

23. The method according to claim 15 for the production of clothing, directly in textile processes including texturizing; twisting; covered yards; knitting; weaving; seamless; circular knitting with other yarns, including cotton, nylon, polyester, polypropylene, cellulosics, wool, silk, polyurethane; warp knitting; beaming process; staple fibers; nonwovens, wherein the textiles can be selected from the group of Denim; Hosiery; Intimate; Sportswear; Fashion; Shoes; Sewing threads; Upholstery; Home textiles; Industrial textiles.
